(19) United States
(12) Patent Application Publication
(10) Pub. No.: US 2020/0074531 A1
(43) Pub. Date: Mar. 5, 2020

(54) Method for Online Order of a Real-Time Investigation

(71) Applicants: Anton Edelman, Netania (IL); Tsah Ezekiel, Oranit (IL)

(72) Inventors: Anton Edelman, Netania (IL); Tsah Ezekiel, Oranit (IL)

(21) Appl. No.: 16/548,837

(22) Filed: Aug. 22, 2019

Related U.S. Application Data
(63) Continuation-in-part of application No. 16/120,901, filed on Sep. 4, 2018.

(51) Int. Cl. G06Q 30/06; H04L 29/08

(52) U.S. Cl. CPC G06Q 30/0635; H04L 67/42; H04L 67/18

(57) ABSTRACT

A method for online order of a real-time investigation performed by a processing device running on an internet device that enables a user of the internet device to use the method as a client or as a provider, enables a client to create an online order of a real-time investigation, to determine a specific target of the order, and to specify information required by the client regarding that specific target, enables the client to specify in the order a physical location at which the specific target is likely to be at a specified time, identifies the physical location at which the order is required to be performed, detects a location of the provider in real-time, sends the order to a provider according to his location, and enables the provider and the client to communicate regarding a performance of the online order of a real-time investigation.

### CROSS-REFERENCE TO RELATED APPLICATIONS

This application is a continuation in part of a U.S. patent application Ser. No. 16/120,901 filed on Sep. 4, 2018.

### TECHNICAL FIELD

The present invention refers to a method for online order of a real-time investigation for immediate performance.

### BACKGROUND ART

In many situations, a person may need the immediate performance of a private investigation service regarding a specific target. The specific target may be a person, a pet, a place, an object and the like. The investigation service may include finding and locating the target, following it and documenting its actions or happenings. When the target is a person, the investigation may include finding and locating the person and filming or photographing his or her actions and providing a report to the person who made the order. When the target is a lost pet or a person, the investigation may include finding the target and informing the person who made the order that the target has been found. When the target is a place, the investigation may include arriving at the place and filming or photographing the place at that time and sending the report to the person who made the order as to what is happening at that place at that moment. The present invention offers an effective solution for these needs by providing a method that is, in fact, a web platform that serves as a platform for placing an online order of real-time investigation tasks as to a specific target for immediate performance.

### DESCRIPTION OF THE DRAWINGS

The intention of the drawings attached to the application is not to limit the scope of the invention and its application. The drawings are intended only to illustrate the invention, and they constitute only one of its many possible implementations.

FIG. 1 is a block diagram that illustrates two internet devices (200), of a provider and a client, each of them includes a processing device (10) and a server (100) with a processing device (10).

### THE INVENTION

The main object of the present patent application is to provide a method performed by a processing device (10) that is designed to enable a user of an internet device (200) to create an online order of a real-time investigation for immediate performance.

The term “internet device” (200) in the present patent application and in the claims refers to any device which is designed to have an internet connection, such as smartphones, computers, tablets and the like.

The term “investigation” in this patent application and in the claims refers to all those kinds of services as stated in the background of the application that may include finding, locating, documenting, filming, photographing, and any other kind of surveillance activities.

The word “immediate” in the term “immediate performance” in this patent application and in the claims refers to a period of time that begins immediately and up to 24 hours.

A web platform such as a computer program may be used as a framework for the overall operation and use of the method, and for the sake of fluency we will use the terms “web platform” and “method” hereinafter in this connection and as having, in general, the same meaning. A user of an internet device (200) may download the web platform which is performed by the processing device (10) of the internet device (200) and may also be performed by a processing device in a server (100).

The method for online order of a real-time investigation for immediate performance performed by a processing device running on an internet device may include the following steps and features:

(a) The method enables a user of the internet device to use (possible to sign-up) the method as a client or as a provider.
(b) The method may enable the user to open an account and to be identified by his or her user account.
(c) The method enables a client to create an online order of a real-time investigation, to determine the specific target of the online order of a real-time investigation and the information that includes documentation required by the client regarding that specific target.
(d) The method enables the client to specify in said online order of a real-time investigation a physical location at which the specific target is likely to be at a specified time. The client may specify in his order that the specific target is now or going to be at a specified time in a specific place, address or specific location. Thus, the providers may have information as to when and where to start the investigation.
(e) The method may enable the client to attach files to the online order of a real-time investigation, such as media files that may include photos, videos, audio files, etc., that may include information about the specific target, for assisting the provider to perform the order properly and efficiently.
(f) The method may enable the client to specify in his online order of a real-time investigation a timeframe in which the online order of a real-time investigation should be performed and/or reported. By that, the method may enable the client to specify the level of urgency in terms of time to perform the order. The client may specify that he or she wants that said performance should be done immediately or within a specific time.
(g) The method may enable the provider to specify an area of activity in which he or she agrees to provide investigation services according to online investigation orders. This area of activity may be a permanent area or additionally or alternatively an area based on the provider current location plus predetermined radius. The term “current location” in this connection means the place in which the provider is located when the order is received. The method may also enable the provider to receive orders only when he is online (the app is opened in his device).

For example: (1) the provider may specify a specific city or county and the like as his or her area of activity; (2) the provider may specify his or her office or home plus specific radius as his or her area of activity; (3) the provider may specify his or her current location plus certain radios as the area of activity (this in addition or alternatively to an area of activity based on a permanent address).

The method may also enable the provider to expand or narrow the area of activity based on the level of urgency in terms of time to perform the online investigation order. For example, the provider may set his or her area of activity as his or her current location plus radius of 3 kilometers when the client needs an immediate performance within 30 minutes, plus radius of 10 kilometers when the client needs the performance within One hour, and plus radius of 25 kilometers when the client needs the performance within 2 hours.

(h) The method may enable the provider to specify that he or she prefers to receive orders that are required to be performed within his or her area of activity.
(i) The method detects the locations of providers in real time. The method may constantly or each period of time detect the locations of the providers when the method is switched on their internet device.
(j) The method identifies the territory in which the online investigation order is required to be performed.
(k) The method sends orders to providers according to their area of activity or as calculated according to the level of urgency in terms of time to perform said online investigation orders.
(l) The method enables the provider and the client to communicate regarding the performance of the online investigation order.

As stated above, the method enables the client to specify in his or her order the required information. For example, the client may ask for: a photo of a specific person that is now sitting in a café and that the photo should depict all the people who are sitting with him around the table (e.g., in cases of a jealous wife that wants to be sure that her husband is not associating with women more attractive than her); information and photos of a person from the moment that he goes outside his office at a specific address at 16:00 until 18:00 including photos with all the people that he met in these two hours (e.g., in cases of person that wishes to know what other person was doing during these specific two hours); a photo of a door of a certain restaurant that is located at specific address now or at a certain time (e.g., in cases when the owner wishes to know whether his employees opened the restaurant at time); to find or locate a pet or a person (e.g., in case when a pet or person was lost in a specific park).

(m) The method enables the client to add to his or her order a price that he or she agrees to pay for said required information or documentation or to add an invitation to receive quotes from providers for said required information or documentation.
(n) The method may associate built-in or external software for blurring images for enabling the provider to blur images; the method enables the provider to send the blurred images to the client for assessment and for negotiating the price for the original unblurred images.
(o) The method may enable the client and the provider to agree as to the price for said required information or documentation, and to document said price and said required information or documentation.
(p) The method may enable the client to pay on-condition the agreed price to the account of the operator of the method.

The payment on-condition can be done by credit card or any other known methods of online payments. When the provider sends the client the required information or documentation, then the client approves the payment, and the payment is transferred to the provider, that in turns transfers the payment or part of it to the operator. In case of disagreement, whether the information or documentation that the provider has sent to the client fulfilled the required information or documentation and/or that this information or documentation has been sent on time, the operator may serve as a decisive arbitrator between the client and the provider.

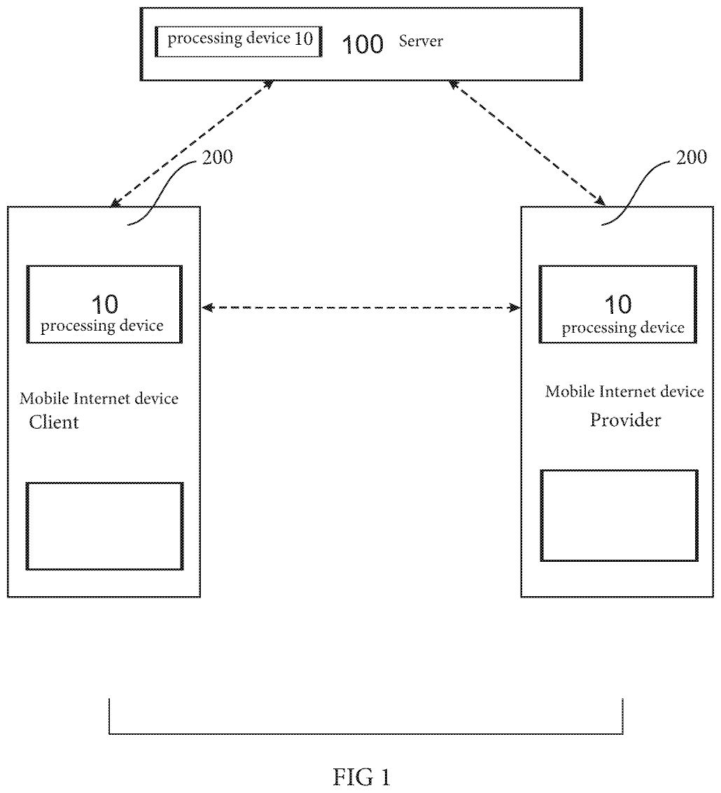

FIG. 1 is a block diagram that illustrates two internet devices (200), of a provider and a client, each of them includes a processing device (10) and a server (100) with a processing device (10).

What is claimed is:

1. A method for online order of a real-time investigation performed by a processing device running on an internet device, comprising:
(a) enabling a user of the internet device to use the method as a client or as a provider;
(b) enabling a client to create an online order of a real-time investigation, to determine a specific target of the online order of a real-time investigation, and to specify information required by the client regarding that specific target;
(c) enabling the client to specify in the online order of a real-time investigation a physical location at which the specific target is likely to be at a specified time;
(d) identifying the physical location at which said online order of a real-investigation is required to be performed;
(e) detecting a location of said provider in real-time;
(f) sending the online order of a real-time investigation to a provider according to his or her location; and
(g) enabling the provider and the client to communicate regarding a performance of the online order of a real-time investigation.
